(19) United States
(12) Patent Application Publication
(10) Pub. No.: US 2007/0026896 A1
(43) Pub. Date: Feb. 1, 2007

(54) Apparatus and method for receiving data signals of two adjacent frequency allocations in cellular environments

(75) Inventors: Ki-Young Han, Yongin-si (KR); Young-Hoon Kwon, Seongnam-si (KR); Sung-Soo Hwang, Suwon-si (KR); Soon-Young Yoon, Seoul (KR); Yong-Seok Kim, Suwon-si (KR); Eun-Sun Choi, Gwacheon-si (KR); Soong-Yoon Choi, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/496,815

(22) Filed: Aug. 1, 2006

(30) Foreign Application Priority Data
Aug. 1, 2005 (KR) 2005-0070125

(51) Int. Cl. H04B 1/38

(52) U.S. Cl. 455/561

(57) ABSTRACT

Provided is an apparatus and method for simultaneously receiving data signals of two adjacent frequency allocation (FA) in a cellular environment. When there is another base station using an adjacent FA to an FA of the base station, a subcarrier mapper maps control information to subcarriers of predetermined sections such that a mobile station simultaneously receives data signals of the adjacent FAs. An inverse fast Fourier transform (IFFT) processor IFFT-processes data mapped to the subcarriers. Because two different BSs transmit the same data through independent paths, the mobile station can obtain a macro diversity gain. Also, it is possible to balance the loads of the two BSs.

### PRIORITY

This application claims priority under 35 U.S.C. § 119 to an application entitled “Apparatus and Method for Simultaneously Receiving Two Adjacent Frequency Allocations in Cellular Environments” filed in the Korean Intellectual Property Office on Aug. 1, 2005 and assigned Serial No. 2005-70125, the contents of which are incorporated herein by reference.

### BACKGROUND OF THE INVENTION

1. Field of the Invention The present invention relates generally to an apparatus and method for receiving data signals of two adjacent frequency allocations (FAs) in cellular environments, and in particular, to an apparatus and method for supporting a frame structure that enables a mobile station (MS) to simultaneously receive data signals from two base stations (BSs) with adjacent FAs in a cellular environment with a frequency reuse factor of N.

2. Description of the Related Art Cellular communication systems have been proposed to overcome the restrictions of a service area and a subscriber capacity. In the cellular communication system, the service area is divided into a plurality of sub-areas (i.e., cells). Two cells spaced apart from each other by a sufficient distance use the same FA such that frequency resources can be spatially reused. Accordingly, the cellular communication system can accommodate a sufficient number of subscribers by increasing the number of spatially-distributed channels.

FIG. 1 is a schematic diagram illustrating a conventional cellular system with a frequency reuse factor of 3. FIG. 1(a) illustrates cells with a frequency reuse factor of 3, and FIG. 1(b) illustrates FAs used in the respective cells.

As illustrated in FIG. 1(a), cells A(101), B(103) and C(105) use different FAs (FA1, FA2 and FA3) illustrated in FIG. 1(b), respectively.

FIG. 2 is a diagram illustrating a frame structure of the Institute of Electrical and Electronics Engineers (IEEE) 802.16 d/e system. In the following description, frame structures of cells with a frequency reuse factor of 3 illustrated in FIG. 1 are taken as an example. In FIG. 2, the axis of ordinate is a subchannel that is a frequency resource unit, and the axis of abscissa is an orthogonal frequency division multiplexing (OFDM) symbol that is a time resource unit.

As illustrated in FIG. 2, the cells A (101), B(103) and C (105) use different FAs (FA1, FA2 and FA3), respectively. A frame used in each cell includes a preamble field, a control information field, and a data field.

The preamble field is used to provide time/frequency synchronization to subscribers and to acquire cell information. The control information field includes a frame control header (FCH), a downlink medium access protocol (DL-MAP), and an uplink MAP (UL-MAP). The FCH contains information for decoding the DL-MAP. A DL-Burst contains information data to be transmitted to a base station. The DL-MAP contains information about locations of DL-Bursts in a frame and information about which user DL-Burst data belongs to. The UL-MAP contains information which section in a frame a user's data can be loaded.

The data field is classified into a DL-Burst and an UL-Burst. The data field is a field where actual data are located. The data field includes at least one subchannel and at least one symbol.

The maximum allowable number of channels per unit area in the above cellular communication system can be increased by reducing a cell radius or by reducing a frequency reuse factor. The frequency reuse factor is parameter that indicates a frequency efficiency rating. That is, the frequency reuse factor indicates how many cells the entire frequency band is distributed to. When the frequency reuse factor decreases, the maximum allowable frequency band per cell increases but a signal-to-interference ratio (SNR) in a cell boundary region increases. On the contrary, when the frequency reuse factor increases, an SNR in a cell boundary region decreases but the maximum allowable frequency band per cell decreases. Accordingly, the frequency reuse factor is determined considering the maximum SNR required by a mobile station.

As described above, the number of channels per unit area can be increased using the frequency reuse factor. However, because two base stations adjacent to each other use different frequency bands, a mobile station cannot simultaneously receive data from the adjacent base stations.

### SUMMARY OF THE INVENTION

An object of the present invention is to substantially solve at least the above problems and/or disadvantages and to provide at least the advantages below. Accordingly, an object of the present invention is to provide an apparatus and method for simultaneously receiving data signals from BSs with adjacent FAs in a cellular environment.

Another object of the present invention is to provide an apparatus and method for supporting a frame structure capable of simultaneously receiving data signals from BSs with adjacent FAs in a cellular environment.

A further object of the present invention is to provide an apparatus and method for simultaneously receiving data signals from BSs with adjacent FAs in a cellular environment, thereby realizing a diversity gain.

According to an aspect of the present invention, a base station apparatus for a broadband wireless communication system with a frequency reuse factor of N includes a subcarrier mapper and an inverse fast Fourier transform (IFFT) processor. When there is another base station using an FA adjacent to an FA of the base station, the subcarrier mapper maps control information to subcarriers of predetermined sections such that a mobile station simultaneously receives data signals of the adjacent FAs. The IFFT processor IFFT-processes data mapped to the subcarriers.

According to another aspect of the present invention, a mobile station apparatus simultaneously receives data signals of two adjacent FAs in a broadband wireless communication system that has a frequency reuse factor of N. When signals are simultaneously received from two base stations using two adjacent FAs, a frequency controller selects a carrier for simultaneously receiving data signals of the two adjacent FAs. A local oscillator generates the carrier selected by the frequency controller. A multiplier multiplies the generated carrier from the local oscillator by a received signal to generate a baseband signal. An analog-to-digital (AID) converter converts the baseband signal from the multiplier into a digital signal. A fast Fourier transform (FFT) processor FFT-processes the digital signal from the AID converter. A subcarrier demapper receives an output signal from the FFT processor and extracts actual data from the output signal from the FFT processor by using control information mapped to a subcarrier of a predetermined section where the two FAs are adjacent to each other.

According to a further aspect of the present invention, there is provided a method for transmitting data from a base station in a broadband wireless communication system with a frequency reuse factor of N. In the method, it is determined whether there is another base station using an FA adjacent to an FA of the base station. When there is the another base station, a frame is created by locating control information such that a mobile station can simultaneously receive data of the two adjacent FAs. The created frame is transmitted to the mobile station.

According to still another aspect of the present invention, there is provided a method for receiving data of two adjacent FAs at a mobile station in a broadband wireless communication system that has a frequency reuse factor of N. When signals are simultaneously received from two base stations, it is determined whether FAs of the two base stations are adjacent to each other. When the FAs of the two base stations are adjacent to each other, the mobile station shifts its FA to simultaneously communicate with the two base stations.

### BRIEF DESCRIPTION OF THE DRAWINGS

The above and other objects, features, and advantages of the present invention will become more apparent from the following detailed description when taken in conjunction with the accompanying drawings in which:

FIG. 1 is a schematic diagram illustrating a conventional cellular system with a frequency reuse factor of 3;

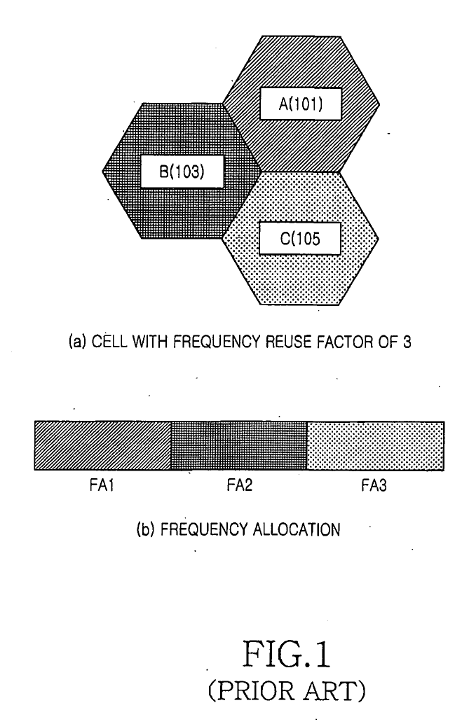

FIG. 2 is a diagram illustrating a frame structure of the IEEE 802.16 d/e system;

FIG. 3 is a schematic diagram illustrating a scheme for simultaneously receiving data signals from two BSs with adjacent FAs, according to the present invention;

FIG. 4 is a schematic diagram illustrating a frame structure of three adjacent FAs, according to the present invention;

FIG. 5 is a schematic diagram illustrating a frame structure of four adjacent FAs, according to the present invention;

FIG. 6 is a block diagram of a BS that enables an MS to simultaneously receive data signals of two adjacent FAs, according to the present invention;

FIG. 7 is a flowchart illustrating a procedure for transmitting data from a BS to an MS according to the present invention, which enables the MS to simultaneously receive data of two adjacent FAs;

FIG. 8 is a block diagram of an MS for simultaneously receiving data signals of two adjacent FAs, according to the present invention; and

FIG. 9 is a flowchart illustrating a procedure for simultaneously receiving data signals of two adjacent FAs, according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail because they would obscure the present invention in unnecessary detail.

The present invention provides an apparatus and method for simultaneously receiving data signals from two BSs with two adjacent FAs in a cellular environment with a frequency reuse factor of N. In the following description, the bandwidth that an MS transmitting a maximum amount of information occupies in the cellular environment is referred to as “FA bandwidth”. Also, the MS and the BSs will be assumed to have the same bandwidth.

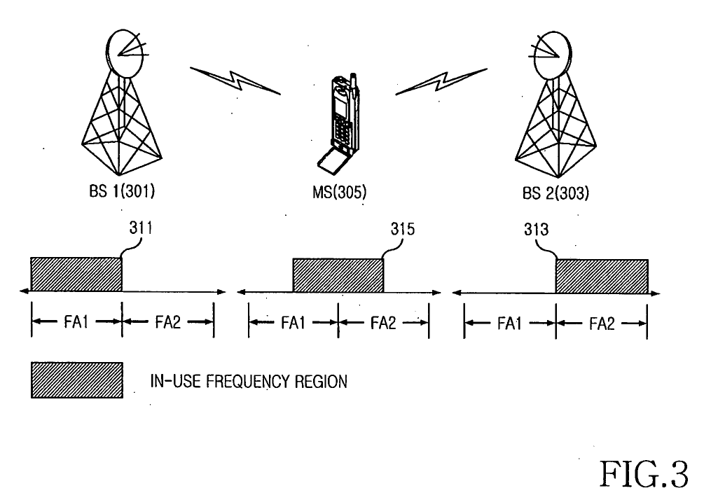

FIG. 3 is a schematic diagram illustrating a scheme for simultaneously receiving data signals from two BSs with adjacent FAs, according to the present invention.

Referring to FIG. 3, first and second BSs 301 and 303 adjacent to each other use different frequency allocations FA1 (311) and FA2 (313), respectively. The first and second FAs 311 and 313 are adjacent to each other. An MS 305 simultaneously receives data signals from the first and second BSs 301 and 303 by shifting its FA 315 such that the FA 315 includes both a portion of the first FA 311 and a portion of the second FA 313.

A demonstration will now be given to show that the MS 305 can selectively receive a desired signal using only the portions of the adjacent FAs 311 and 313. In the following description, an OFDM communication system is taken as an example.

Equation (1) below represents transmission (TX) signals x₁(t) and X₂(t) that are transmitted from the BSs 301 and 303 to the MS 305.

$${x}_{1} ( t ) = \frac{1}{\sqrt{N}} {\sum }_{k = - \frac{N}{2}}^{\frac{N}{2} - 1} {X}_{1} [ k ] exp ( j \frac{2 π kt}{{NT}_{s}} ) exp ( j2π {f}_{c 1} t ) \\ {x}_{2} ( t ) = \frac{1}{\sqrt{N}} {\sum }_{k = - \frac{N}{2}}^{\frac{N}{2} - 1} {X}_{2} [ k ] exp ( j \frac{2 π kt}{{NT}_{s}} ) exp ( j2π {f}_{c 2} t ) \qquad ( 1 )$$

where N is the size of the fast Fourier transform (FFT), Tₛ is sampling time, fc₁ an fc₂ are carrier frequencies of the TX signals x₁(t) and X₂(t), and X₁[k] and X₂[k] are TX data transmitted from the BSs 301 and 303.

The TX signals x₁(t) and x₂(t) are received at a receiver of the MS 305 on a channel h. The received signals are down-converted into a baseband signal y(t) of Equation (2):

$$y ( t ) = \{ {\sum }_{l = 0}^{L - 1} {h}_{1 , l} {x}_{1} ( t - {τ}_{1} ) + {h}_{2 , l} {x}_{2} ( t - {τ}_{1} ) \} exp ( - j2π {f}_{cm} t ) \qquad ( 2 )$$

where L is the number of multipaths generated during the transmission of the TX signals x₁(t) and x₂(t), τ₁ is a delay of the l^{th} path,f_{cm} is a carrier frequency of the MS 305, and h₁ and h₂ are channels on which the TX signals x₁(t) and X₂(t) are received.

When the carrier frequency f_{cm} is assumed to be the average of carrier frequencies of the BSs 301 and 303, the baseband signal y(t) of Equation (2) can be simplified into a time-domain signal y[n] of Equation (3) below by low-pass filtering and sampling at every sampling time T_{S}.

$$y [ n ] = \frac{1}{\sqrt{N}} [ {\sum }_{l = 0}^{L - 1} \{ {h}_{1 , l} {\sum }_{k = 0}^{\frac{N}{2} - 1} {X}_{1} [ k + \frac{N}{2} ] exp ( j \frac{2 π ( n - l ) k}{N} ) + {h}_{2 , l} {\sum }_{k = \frac{N}{2} - 1}^{- 1} {X}_{2} [ k ] exp ( j \frac{2 π ( n - l ) ( k + \frac{N}{2} )}{N} ) \} ] \qquad ( 3 )$$

where N is the size of the FFT, L is the number of multipaths generated during the transmission of the TX signals x₁(t) and x₂(t), and h₁ and h₂ are channels on which the TX signals x,(t) and x₂(t) are received.

When data to be transmitted from the BSs 301 and 303 to the MS 305 are represented by X[k], the time-domain signal y[n] of Equation (3) can be expressed as a time-domain signal y[n] of Equation (4):

$$y [ n ] = \frac{1}{\sqrt{N}} [ {\sum }_{l = 0}^{L - 1} \{ {h}_{1 , l} {\sum }_{k = - \frac{N}{2}}^{- 1} X [ k ] exp ( j \frac{2 π ( n - l ) k}{N} ) + {h}_{2 , l} {\sum }_{k = 0}^{\frac{N}{2} - 1} X [ k ] exp ( j \frac{2 π ( n - l ) k}{N} ) \} ] \qquad ( 4 )$$

where N is the size of the FFT, L is the number of multipaths generated during the transmission of the TX signals x₁(t) and X₂(t), and h₁ and h₂ are channels on which the TX signals x₁(t) and X₂(t) are received.

Thereafter, when an FFT operation is performed on Equation (4), the time-domain signal y[n] of Equation (4) can be expressed as a frequency-domain signal Y[t] of Equation (5):

$$Y [ t ] = \{ \begin{matrix}X [ k ] {\sum }_{l = 0}^{L - 1} {h}_{1 , l} exp ( - j \frac{2 π lk}{N} ) , - \frac{N}{2} \leq k \leq - 1 \\ X [ k ] {\sum }_{l = 0}^{L - 1} {h}_{2 , l} exp ( - j \frac{2 π lk}{N} ) , 0 \leq k \leq \frac{N}{2} - 1\end{matrix} \qquad ( 5 )$$

As can be seem from Equation (5), even though the MS 305 uses only the portions of the FAs 311 and 313 of the BSs 301 and 303, it can normally receive the data signals from the BSs 301 and 303.

However, in order to successfully communicate with the BSs 301 and 303, the MS 305 must be able to accurately detect a preamble and control information using the portions of the FAs 311 and 313. That is, the MS 305 must be able to perform functions such as cell identification (ID), synchronization, channel estimation, and frequency offset estimation using the preamble contained in the portions of the FAs 311 and 313. At this point, the preamble is generated by combining a pseudo noise (PN) sequence corresponding to a predetermined FA bandwidth with a scrambling code for discriminating between BSs.

Also, the location of data corresponding to the MS 305 must be accurately detected using the control information contained in the portions of the FAs 311 and 313.

What is therefore required is a frame structure for accurately receiving the preamble and the control information using only the portions of the FAs 311 and 313.

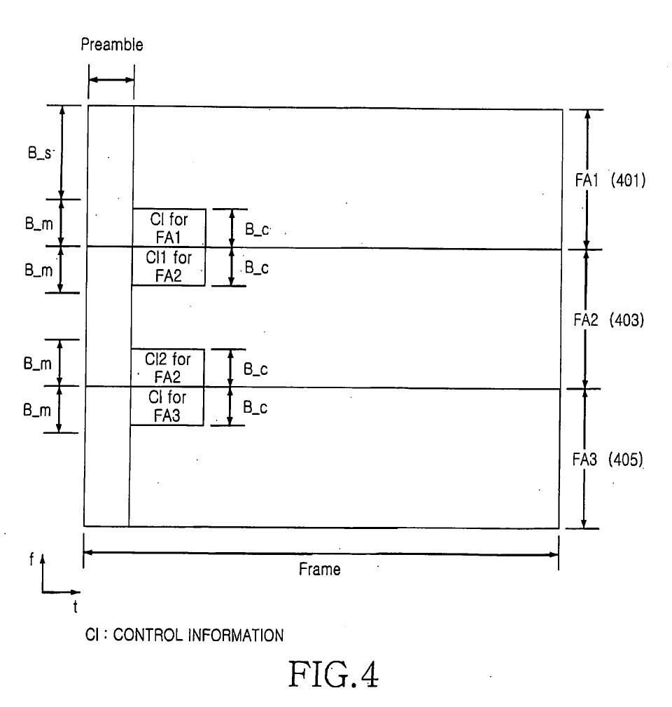

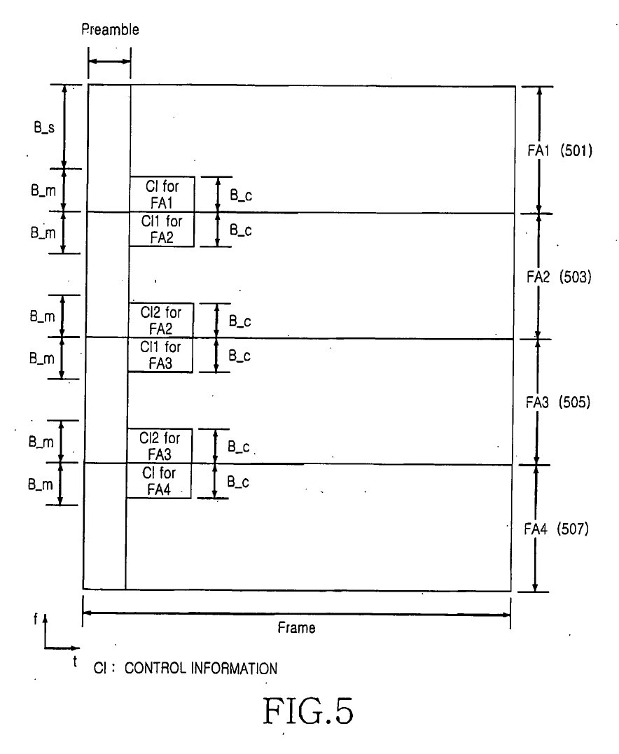

FIGS. 4 and 5 are schematic diagrams illustrating frame structures according to the present invention. FIG. 4 illustrates a method for locating the control information in a frame structure using three adjacent FAs, while FIG. 5 illustrates a method for locating the control information in a frame structure using four adjacent FAs. A bandwidth necessary for transmission of a maximum amount of control information will be referred to as “B_c”. Also, a bandwidth necessary for the minimum scrambling code length for the primary function of the preamble will be referred to as “B_p”. Also, the minimum bandwidth where the frequency band of the MS overlaps the frequency band of each of the FAs will be referred to as “B_m”.

Referring to FIGS. 4 and 5, the control information is located in a section where the FAs are adjacent to each other such that the MS can simultaneously receive data over the adjacent FAs. For example, the control information is located between the first and second FAs 401 and 403 in FIG. 4, between the second and third FAs 403 and 405 in FIG. 4, between the first and second FAs 501 and 503 in FIG. 5, between the second and third FAs 503 and 505 in FIG. 5, and between the third and fourth FAs 505 and 507 in FIG. 5.

In particular, because each of the second FA 403, the second FA 503, and the third FA 505 have adjacent FAs at both sides, the control information is located at the both sides of each of the FAs 403, 503, and 505. At this point, the control information located at both sides of each of the FAs 403, 503 and 505 may be different in the both sides because different MSs may be located at both sides of each of the FAs 403, 503 and 505.

As illustrated in FIGS. 4 and 5, the adjacent FAs overlap each other at least by the minimum bandwidth B_m. At this point, the minimum bandwidth B_m must be larger than the maximum of the bandwidth B_c or B_p.

Assuming that the bandwidth of the FA is B, a band shift amount B_s for allowing the MS to simultaneously use the adjacent FAs is at least the FA bandwidth B and up to (B-B_m).

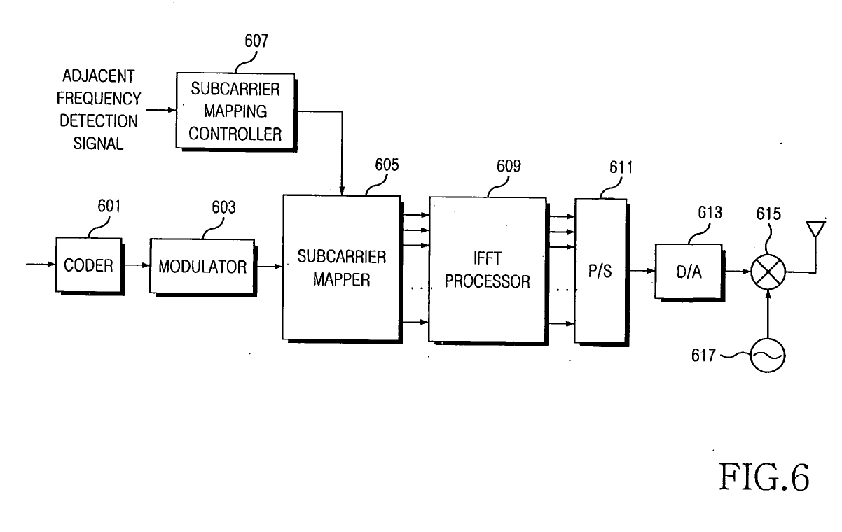

FIG. 6 is a block diagram of a BS that enables an MS to simultaneously receive data signals of two adjacent FAs, according to the present invention.

Referring to FIG. 6, the BS includes a coder 601, a modulator 603, a subcarrier mapper 605, a subcarrier mapping controller 607, an inverse FFT (IFFT) processor 609, a parallel-to-serial (P/S) converter 611, a digital-to-analog (D/A) converter 613, a multiplier 615, and a local oscillator 617.

The coder 601 performs channel-coding on input information data from a medium access control (MAC) layer at a predetermined coding rate to output the resulting data to the modulator 603. The modulator 603 modulates the data from the coder 601 by a predetermined modulation scheme to output the resulting data to the subcarrier mapper 605. Examples of the predetermined modulation scheme are the binary phase shift keying (BPSK) modulation scheme, the quadrature phase shift keying (QPSK) modulation scheme, the 16-QAM (quadrature amplitude modulation) scheme, and the 64-QAM scheme.

The subcarrier mapper 605 performs a subcarrier-mapping operation on the data from the modulator 603 under the control of the subcarrier mapping controller 607 to output the resulting data (i.e., frequency-domain data) to the IFFT processor 609. At this point, when there is another BS using an FA adjacent to an FA used by the BS, the subcarrier mapping controller 607 generates a control signal for mapping control information into a section where the FAs are adjacent to each other as illustrated in FIGS. 4 and 5.

The IFFT processor 609 IFFT-processes the frequency-domain data from the subcarrier mapper 605 to output time-sampled data (i.e., parallel data) to the P/S converter 611. The P/S converter 611 converts the parallel data from the IFFT processor 609 into serial data to output the resulting data (i.e., a digital signal) to the D/A converter 613. The D/A converter 613 converts the digital signal from the P/S converter into an analog signal to output an analog baseband signal to the multiplier 615. The multiplier 615 multiplies the analog baseband signal from the D/A converter 613 by an oscillating signal from the local oscillator 617 to generate a radio-frequency (RF) signal. The multiplier 615 and the local oscillator 617 constitute an RF processor. The RF signal is transmitted through an antenna.

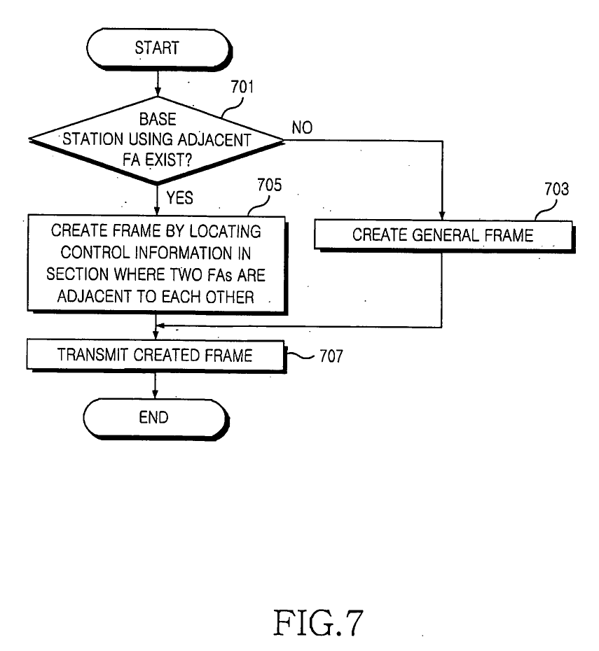

FIG. 7 is a flowchart illustrating a procedure for transmitting data from a BS to an MS according to the present invention, which enables the MS to simultaneously receive data of two adjacent FAs.

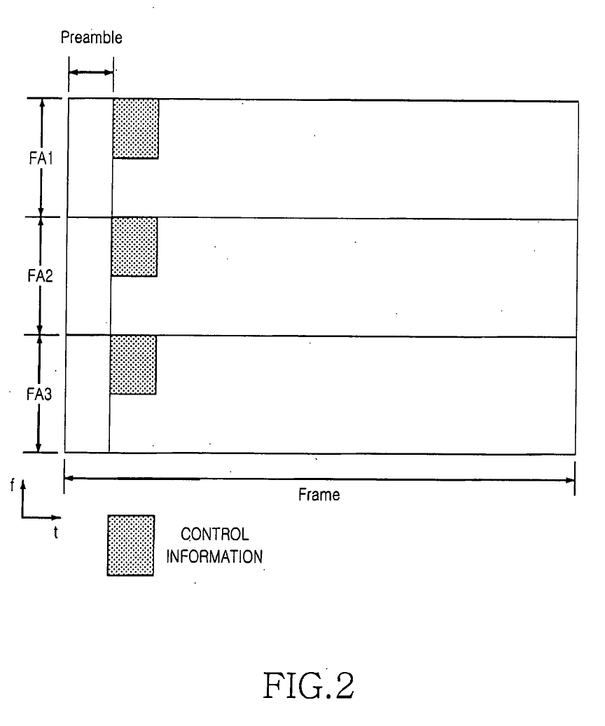

Referring to FIG. 7, in order to transmit data to an MS, the BS determines in step 701 if there is an adjacent BS using an FA adjacent to its FA. If so, the procedure proceeds to step 705, but if not, the procedure proceeds to step 703 and then to step 707. In step 703, the BS creates a general frame illustrated in FIG. 2 before transmitting the general frame in step 707.

In step 705, the BS maps control information into a section where the FA of the BS and the FA of the adjacent BS are adjacent to each other, as illustrated in FIGS. 4 and 5. Also, a preamble for discriminating the BS is repeatedly mapped throughout the entire FA of the BS to create a frame. The preamble includes a scrambling code for discriminating the BS.

In step 707, the BS transmits the created frame to the MS. Thereafter, the BS ends the procedure.

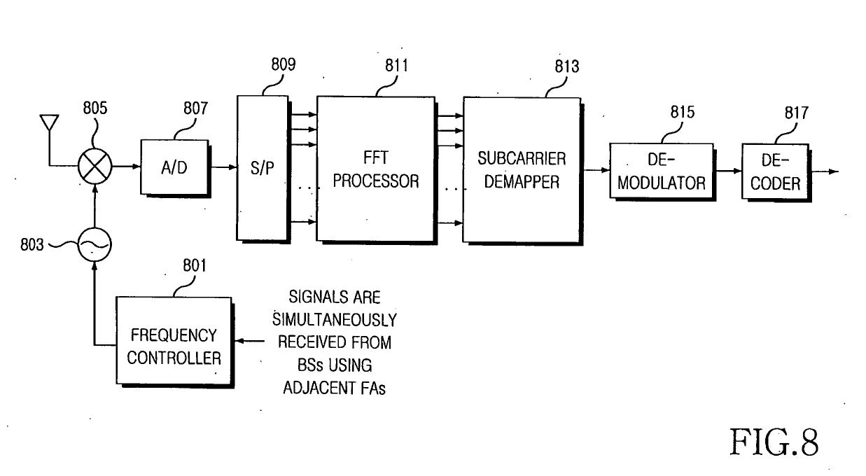

FIG. 8 is a block diagram of an MS for simultaneously receiving data signals of two adjacent FAs, according to the present invention.

Referring to FIG. 8, the MS includes a frequency controller 801, a local oscillator 803, a multiplier 805, an analog-to-digital (A/D) converter 807, a serial-to-parallel (S/P) converter 809, an FFT processor 811, a subcarrier demapper 813, a demodulator 815, and a decoder 817.

The frequency controller 801 generates a control signal for selecting an FA to be used by the MS. That is, because the MS uses a predetermined bandwidth, the frequency controller 801 generates a control signal for selecting a carrier that is a center frequency of the MS. Also, when simultaneously receiving signals from two BSs using two adjacent FAs, the frequency controller 801 generates a control signal for selecting a carrier for simultaneously receiving data from the two adjacent BSs. The local oscillator 803 generates the carrier (i.e., the center frequency of the BS) under the control of the frequency controller 801. At this point, the carrier is selected such that it includes a preamble of the minimum bandwidth for discriminating between the BSs and control information of each of the two adjacent FAs.

The multiplier 805 multiplies a signal received through an antenna by a carrier received from the local oscillator 803, thereby creating an FA for simultaneously receiving signals from the two base stations. The A/D converter 807 converts an output signal from the multiplier 805 into a digital signal. The digital signal is time-sampled data (i.e., serial data).

The S/P converter 809 coverts the serial data from the A/D converter 807 into parallel data. The FFT processor 811 FFT-processes the parallel data from the S/P converter 809 to output frequency-domain data.

The subcarrier demapper 813 extracts subcarrier values loaded with actual data from the output signal (i.e., subcarrier values) of the FFT processor 811. According to the present invention, the actual data of each FA is extracted using control information that is loaded into a subcarrier of a predetermined section where the two FAs are adjacent to each other.

The demodulator 815 demodulates the actual data from the subcarrier demapper 813 by a predetermined demodulation scheme. The decoder 817 performs a channel-decoding operation on the decoded data from the demodulator 815 at a predetermined coding rate, thereby restoring information data.

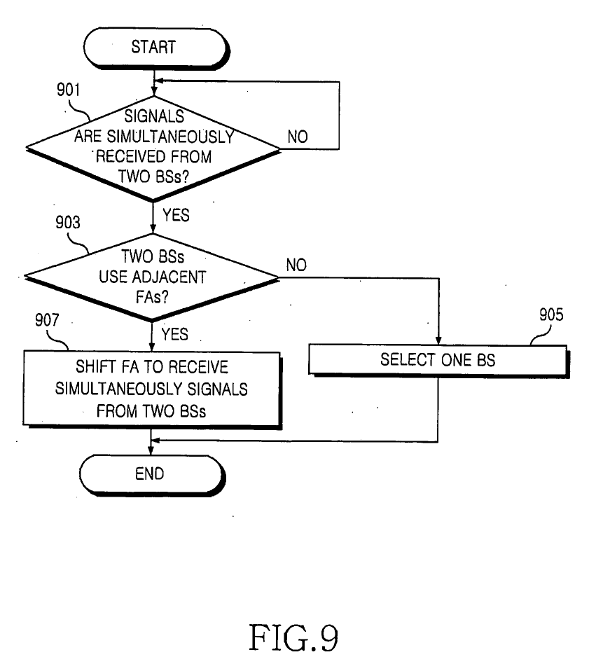

FIG. 9 is a flowchart illustrating a procedure for simultaneously receiving data signals of two adjacent FAs, according to the present invention.

Referring to FIG. 9, an MS determines in step 901 if it simultaneously receives signals from two BSs in step 901. If so, the MS proceeds to step 903, and if not, the BS performs step 901 again. In step 903, the MS determines if FAs used by the two BSs are adjacent to each other. If so, the MS proceeds to step 907, and if not, the MS proceeds to step 905. In step 905, the MS measures RX signal strengths (e.g., pilot strengths) of the two BSs to select the BS with a stronger RX signal, and receives data from the selected BS. Thereafter, the MS ends the procedure.

In step 907, the MS shifts an FA to simultaneously receive the data from the two BSs, as illustrated in FIG. 3. Thereafter, the MS ends the procedure.

As described above, the present invention provides a frame structure that makes it possible for an MS to receive both of data signals of two adjacent FAs in a cellular environment with a frequency reuse factor of N. The MS can simultaneously communicate with BSs that use the adjacent FAs. Because two different BSs transmit the same data through independent paths, the MS can obtain a macro diversity gain. In a case where a first BS is short in capacity while a second BS adjacent to the first BS is abundant in capacity, the MS simultaneously communicates with the first and second BSs such that the first BS transmits a small amount of data while the second BS transmits a large amount of data, thereby making it possible to balance the loads of the two BSs.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A base station apparatus for a wireless communication system with a frequency reuse factor of N, the apparatus comprising:
a subcarrier mapper for mapping, when there is another base station using an frequency allocation (FA) adjacent to an FA of the base station, control information to subcarriers of predetermined sections such that a mobile station simultaneously receives data signals of the adjacent FAs; and
an inverse fast Fourier transform (IFFT) processor for IFFT-processing data mapped to the subcarriers.

2. The base station apparatus of claim 1, further comprising:
a coder for receiving information data from a medium access control (MAC) layer and coding the received information data at a predetermined coding rate; and
a modulator for modulating the coded data from the coder by a predetermined modulation scheme and providing the resulting data to the subcarrier mapper.

3. The base station apparatus of claim 1, wherein the control information includes a preamble and channel allocation information.

4. The base station apparatus of claim 3, wherein the preamble is repeatedly mapped throughout the entire FA of the base station.

5. The base station apparatus of claim 3, wherein the channel allocation information is mapped to subcarriers of a predetermined section where the two FAs are adjacent to each other.

6. The base station apparatus of claim 3, wherein when there are FAs adjacent respectively to both side sections of the FA, two pieces of the channel allocation information are mapped to subcarriers of the both side sections of the FA.

7. The base station apparatus of claim 6, wherein the two pieces of the channel allocation information are one of identical to and different from each other depending on the mobile station using data allocated to the FA.

8. The base station apparatus of claim 1, further comprising:
a digital-to-analog (D/A) converter for converting an output signal of the IFFT processor into an analog signal; and
a radio-frequency (RF) processor for converting a baseband analog signal from the D/A converter into an RF signal to output the resulting analog signal to the mobile station through an antenna.

9. A mobile station apparatus for simultaneously receiving data signals of two adjacent frequency allocations (FAs) in a wireless communication system that has a frequency reuse factor of N, the apparatus comprising:
a frequency controller for selecting, when signals are simultaneously received from two base stations using two adjacent FAs, a carrier for simultaneously receiving data signals of the two adjacent FAs;
a local oscillator for generating the carrier selected by the frequency controller; and
a multiplier for multiplying the generated carrier from the local oscillator by a received signal to generate a baseband signal.

10. The mobile station apparatus of claim 9, wherein the carrier is selected such that the carrier includes a preamble of a minimum bandwidth for discriminating between the base stations and channel allocation information of each of the two adjacent FAs.

11. The mobile station apparatus of claim 10, wherein the channel allocation information is included in a predetermined section where the two FAs are adjacent to each other.

12. The mobile station apparatus of claim 10, wherein when two FAs are adjacent respectively to both side sections of the FA, the channel allocation information is included in subcarriers of the both side sections of the FA.

13. The mobile station apparatus of claim 10, wherein the preamble is disposed throughout the entire FA of the base station so as to discriminate the base station.

14. The mobile station apparatus of claim 9, further comprising:
an analog-to-digital (A/D) converter for converting the baseband signal from the multiplier into a digital signal;
a fast Fourier transform (FFT) processor for FFT-processing the digital signal from the A/D converter; and
a subcarrier demapper for receiving an output signal from the FFT processor and extracting actual data from the output signal from the FFT processor by using control information mapped to a subcarrier of a predetermined section where the two FAs are adjacent to each other.

15. A method for transmitting data from a base station in a wireless communication system with a frequency reuse factor of N, the method comprising the steps of:
determining whether there is another base station using a frequency allocation (FA) adjacent to an FA of the base station;
when there is the another base station, creating a frame by locating control information such that a mobile station can simultaneously receive data of the two adjacent FAs; and
transmitting the created frame to the mobile station.

16. The method of claim 15, wherein the control information includes a preamble and channel allocation information.

17. The method of claim 16, wherein the preamble is repeatedly mapped throughout the entire FA of the base station.

18. The method of claim 16, wherein the channel allocation information is mapped to subcarriers of a predetermined section where the two FAs are adjacent to each other.

19. The method of claim 16, wherein when there are FAs adjacent respectively to both side sections of the FA, two pieces of the channel allocation information are mapped to subcarriers of the both side sections of the FA.

20. The method of claim 19, wherein the two pieces of the channel allocation information are one of identical to and different from each other depending on a mobile station using data allocated to the FA.

21. A method for receiving data of two adjacent frequency allocations (FAs) at a mobile station in a wireless communication system that has a frequency reuse factor of N, the method comprising the steps of:
when signals are simultaneously received from two base stations, determining whether FAs of the two base stations are adjacent to each other; and
when the FAs of the two base stations are adjacent to each other, simultaneously communicating with the two base stations by shifting an in-use FA of the mobile station.

22. The method of claim 21, further comprising, when the FAs of the two base stations are not adjacent to each other:
measuring the strength of a received (RX) signal; and
selecting from the two base stations the base station whose detected RX signal strength is greater than that of the other base station.

23. The method of claim 21, wherein the shifting of the in-use FA of the mobile station comprises:
selecting a carrier for simultaneously receiving data of the two adjacent FAs; and
multiplying the selected carrier by a received signal to move to an FA for simultaneously receiving data of the two adjacent FAs.

24. The method of claim 23, wherein the carrier is selected such that the carrier includes a preamble of a minimum bandwidth for discriminating between the base stations and channel allocation information of each of the two adjacent FAs.

25. The method of claim 24, wherein the channel allocation information is included in a predetermined section where the two FAs are adjacent to each other.

26. The method of claim 24, wherein when two FAs are adjacent respectively to both side sections of the FA, the channel allocation information is included in subcarriers of the both side sections of the FA.

27. The method of claim 24, wherein the preamble is disposed throughout the entire FA of the base station so as to discriminate the base station.
